(19) United States
(12) Patent Application Publication
(10) Pub. No.: US 2017/0019575 A1
(43) Pub. Date: Jan. 19, 2017

(54) Optical Methods and Devices For Enhancing Image Contrast In the Presence of Bright Background

(71) Applicants: Harbans Dhadwal, Setauket, NY (US); Jahangir S. Rastegar, Stony Brook, NY (US)

(72) Inventors: Harbans Dhadwal, Setauket, NY (US); Jahangir S. Rastegar, Stony Brook, NY (US)

(73) Assignee: Omnitek Partners LLC, Ronkonkoma, NY (US)

(21) Appl. No.: 14/808,837

(22) Filed: Jul. 24, 2015

Related U.S. Application Data
(60) Provisional application No. 62/028,779, filed on Jul. 24, 2014.

(51) Int. Cl. H04N 5/238; G02B 21/36; G02B 27/09; G02B 23/24; H04N 5/235; H04N 5/225

(52) U.S. Cl. CPC H04N 5/238; H04N 5/2351; H04N 5/2256; H04N 5/2253; H04N 5/2254; G02B 27/0988; G02B 23/243; G02B 23/2484; G02B 21/361

(57) ABSTRACT

A device including: a light source for outputting illumination light to an object to be imaged; an image sensor for an image of the object as illuminated by the light source; a first objective lens for focusing the illumination light on the object; and a spatial filter positioned in an optical path at a spatial frequency plane of the first objective lens, the spatial filter having an opaque central region and a transparent region outside of the central region, the opaque central region being such that it improves contrast of the image on the image sensor.

### CROSS-REFERENCE TO RELATED APPLICATION

This application claims the benefit to earlier filed U.S. Provisional Application No. 62/028,779 filed on Jul. 24, 2014, the entire contents of which is incorporated herein by reference.

### BACKGROUND OF THE INVENTION

1. Field of the Invention

The present invention relates generally to methods and devices for enhancing image contrast in the presence of bright background, and more particularly to image contrast enhancing methods and devices for the entire range of endoscopy, confocal endomicroscopy, and other similar devices used for imaging bright field objects, such as, human tissue, highly reflective semiconductor elements on wafers or MEM structures or the like.

2. Prior Art

The extraction of high contrast images of objects buried in a bright field background, such as those encountered in endoscopy and other similar medical devices and in devices used for imaging micro or nano-scale objects such as MEMS devices continues to challenge the entire optical imaging industry.

All existing solutions to date are mostly based on processing the digital images that are obtained after optical detection. However, this is a losing battle as the object information, which may have a total energy content of less than 1%, has been lost during optical detection and quantization. Additionally, the other 99% of the energy from the background adds significant shot noise during the optical detection process, further reducing the signal to noise ratio and image contrast. This is the case for both for devices with single wavelength coherent light sources as well as those with white light illumination.

### SUMMARY OF THE INVENTION

A need therefore exists for methods and devices for significantly enhancing image contrast in the presence of bright background in devices such as various endoscopy and confocal endomicroscopy and other similar medical devices and for imaging bright field objects, such as, human tissue, devices on highly reflective semiconductor wafers or MEM structures or the like.

A need also exist for methods and devices for significantly enhancing image contrast when the light source in the devices is a single wavelength coherent light source. Such devices are widely used in medical and other industrial and commercial applications in which the captured imaging does not have to be in color to serve their intended purposes.

A need also exists for methods and devices for significantly enhancing image contrast when the captured images have to be in color to serve their intended user purposes, such as during laparoscopic surgery.

A need also exists for methods and devices for significantly enhancing image contrast in various confocal endomicroscopy devices.

A need also exists for methods and devices for significantly enhancing image contrast in various devices such as endoscopy and confocal endomicroscopy and other similar medical devices and for imaging bright field objects, such as, human tissue, devices on highly reflective semiconductor wafers or MEM structures or the like using white light illumination sources.

A need also exists for devices for enhancing imaging contrast that can be readily attached to existing endoscopy and confocal endomicroscopy and other similar aforementioned devices without requiring any significant change or modification to such devices. As such, any user should be able to incorporate the present devices into their endoscopy and confocal endomicroscopy and other similar devices with minimal effort.

A need also exists for devices for enhancing imaging contrast that can be used for visual inspection of nano and micro-devices and other structures on silicon wafers and other micro and nano-structures and devices that are machined or etched or deposited or the like on other types of material substrates and the like that share the same problems of imaging microscopic features on highly reflective surfaces.

The present methods and devices for enhancing images can be used to enhance imaging contrast in many devices, including medical devices, such as medical endoscopy devices. Hereinafter, the methods and devices will be described mostly as applied to medical endoscopy systems without intending to limit the described methods and devices to such endoscopy systems.

Accordingly, novel methods and novel classes of optical imaging devices that would enhance image contrast in the presence of a bright field by orders of magnitude are provided. The disclosed method and devices can be used in devices with single wavelength coherent light sources. The disclosed novel methods and devices provide an innovative optical solution to significantly enhance imaging contrast under coherent as well as under incoherent illumination, through rejection of the background optical energy.

Also provided are methods and devices that can be used in endoscopy and confocal endomicroscopy and other aforementioned similar devices to provide high contrast full color images.

Also provided are devices that can be used as super-lens attachments that would easily mate to the proximal end of conventional endoscopes and microscopes, replacing either the eyepiece or the imaging lens depending on the endoscope design, without requiring any modification to the endoscope itself.

The user base for the present novel methods and devices for image contrast enhancement is very broad and may be separated into two basic categories: in vivo cellular imaging and visual inspection of nano and micro-structures and the like. The provision of images with orders of magnitude better contrast in the former category will have a profound effect on the quality of services provided to patients in need of medical procedures using endoscopy and confocal endomicroscopy for the early discovery of disease, and in vivo optical biopsy and minimally invasive surgery. Some of these procedures are gastrointestinal tract infections, Barrett's Esophagus, celiac diseases, inflammatory bowel disease, colorectal cancer, gastric cancer, urinary tract, cervical intraepithelial neoplasia, ovarian cancer, head and neck and lung. The surgeons performing such procedures are generally dissatisfied with the image contrast of existing devices and are demanding high contrast images, in particular, for improving the contrast of images during laparoscopic surgery. Enhanced image contrast is a sought out metric for users of biomedical imaging systems. An increase of around two orders of magnitude in imaging contrast which is achievable using the disclosed novel methods and devices will have direct consequence on the productivity of surgeons and significantly reduce the chances of damage to peripheral tissue and nerves. Using such contrast enhanced imaging systems, the medical professionals are able to identify disease earlier, reduce the number of repeat procedures and improve surgical margin detection.

In one embodiment, using the disclosed novel methods, a single wavelength based “Coherent Image Contrast Enhancer” is presented that can be fabricated as a super-lens attachment, which easily mates to the proximal end of conventional endoscopes and microscopes.

In another embodiment, using the disclosed novel methods, multi-wavelength illumination is used to provide similarly high contrast imaging in color, which enables in vivo imaging of bright field objects, such as, human tissue, highly reflective semiconductor wafers or MEM structures or the like in full color.

In yet another embodiment, an “active image contrast enhancer” device is developed that can is capable of achieving the aforementioned high contrast imaging in confocal endomicroscopy.

The developed image contrast enhancing devices developed using the disclosed methods also provide a significant contrast enhancement under incoherent illumination conditions.

### BRIEF DESCRIPTION OF THE DRAWINGS

These and other features, aspects, and advantages of the apparatus of the present invention will become better understood with regard to the following description, appended claims, and accompanying drawings where:

FIG. 1a illustrates a schematic of the first embodiment of the first indicated class of optical imaging methods and devices. FIG. 1b illustrates a detailed enlarged portion of FIG. 1a.

FIG. 2 illustrates typical intensity profiles at the “object plane”, “frequency plane” and image plane” of the optical imaging embodiment of FIG. 1a.

FIG. 3a illustrates a schematic of the second embodiment of the first indicated class of optical imaging methods and devices as applied to an endoscope. FIGS. 3b and 3c illustrate detailed enlarged portions of FIG. 3a.

FIG. 4a illustrates a schematic of the third embodiment of the first indicated class of optical imaging methods and devices as applied to an endoscope with a camera end. FIG. 4b illustrates a detailed enlarged portion of FIG. 4a.

FIG. 5a illustrates a functional block diagram of the coherent image contrast enhancer device of the fourth embodiment. FIGS. 5b and 5c illustrate detailed enlarged portions of FIG. 5a.

FIG. 6a illustrates a functional block diagram of the image enhancer device embodiment with multi-wavelength coherent light sources to achieve high contrast partial or full color imaging. FIG. 6b illustrates a detailed enlarged portion of FIG. 6a.

### DETAILED DESCRIPTION OF THE PREFERRED EMBODIMENT

The embodiments and their method of developing them may be divided into the following three novel classes. An objective of such three classes of optical imaging methods and devices is to significantly enhance image contrast in general, and in the presence of bright illumination field, mostly by up to two orders of magnitude or even better.

A first novel class of optical imaging methods and devices belong to those for use in systems that utilize a single wavelength coherent light source for object illuminations. Hereinafter, the optical imaging devices belonging to this class are referred to as “Coherent Image Contrast Enhancers” (CICE), which are preferably designed and fabricated as super-lens attachment, which easily mates to the proximal end of conventional endoscopes and microscopes and the like replacing either the eyepiece or the imaging lens depending on the endoscope design, without requiring any modification to the devices. This class of optical imaging devices would also significantly enhance imaging contrast when an object is subjected to white light illumination.

The second novel class of optical imaging methods and devices belong to those that use multi-wavelength coherent light sources for object illumination for the purpose of providing high contrast imaging in a certain range or even in full color. Hereinafter, the optical imaging devices belonging to this class are referred to as “Multi-Coherent-Source Image Contrast Enhancers” (MCSICE), which can be designed and fabricated as a super-lens attachment, which easily mates to the proximal end of conventional endoscopes and microscopes and the like replacing either the eyepiece or the imaging lens depending on the endoscope design, without requiring any modification to the devices. The MCSICE devices would enable full color in vivo imaging of bright field objects, such as, human tissue, highly reflective semiconductor wafers or MEM structures or the like. This class of optical imaging devices would also significantly enhance imaging contrast when an object is subjected to white light illumination.

The third novel class of optical imaging methods and devices belong to those that are designed for confocal endomicroscopy and other similar devices in which the image contrast enhancing devices have to be capable of adapting to the varying optical geometry of the devices. The devices may be using a single wavelength coherent light source or multi-wavelength coherent light sources for object illumination. Hereinafter, the optical imaging devices belonging to this class are referred to as “Active Image Contrast Enhancers” (ACICE), which can be designed and fabricated as super-lens attachment, which easily mates to the proximal end of conventional endoscopes and microscopes and the like replacing either the eyepiece or the imaging lens depending on the endoscope design, without requiring any modification to the devices. This class of optical imaging devices would also significantly enhance imaging contrast when an object is subjected to white light illumination.

In relation to endoscopy and confocal endomicroscopy and the like devices used in the medical field and the aforementioned industrial areas, the industry is moving toward modular laparoscopic instruments, with the introduction of tools such as improved imaging systems, 3D laparoscopic instruments, multiple robotic devices and other new instruments are over the horizon. The novel methods and devices disclosed herein provide a significant improvement in the full range of endoscopic devices by an order of magnitude improvement in their imaging contrast. As an example, the rapidly increasing field of minimally invasive surgery would greatly benefit from such imaging contrast enhancement that can be achieved during laparoscopic surgery is live feed of in vivo optical images. Similarly and as an example, in industries designing and fabricating nano- and micro-scale devices, the provision of the means to significantly enhance imaging contrast in inspection, quality control, fabrication and assembly equipment would significantly increase production efficiency and quality as well as cost.

The novel methods and device embodiments disclosed herein take advantage of the accepted fact that the object function has a much higher frequency content in comparison with the bright background light. Consequently, the bright field distribution appears as a point at the origin of the spatial frequency plane, whereas the object energy distributes over the entire frequency plane. Thus, an opaque (or graded transmission or reflecting) disk, positioned at the origin of the spatial frequency plane blocks transmission of the bright field to the image plane. In the different embodiments, the imaging systems separate the object function from the bright field, thereby allowing for full use of the dynamic range of the detector and quantizer and making it possible to achieve high contrast imaging. It will be appreciated by those skilled in the art that almost all currently available image enhancing software algorithms may still be utilized for processing the captured image data.

Hereinafter, the different embodiments for each one of the aforementioned three classes of optical imaging methods and devices are described in detail.

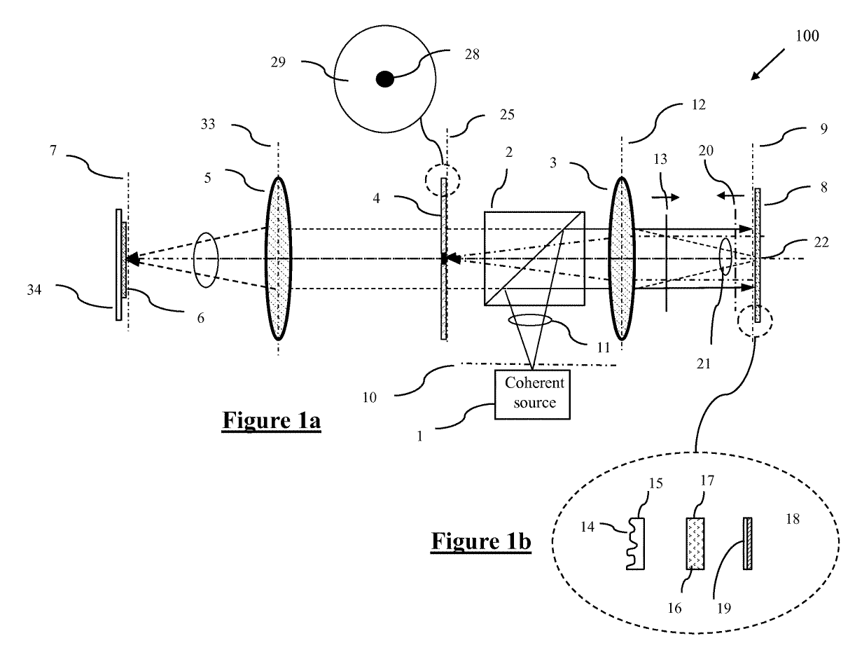

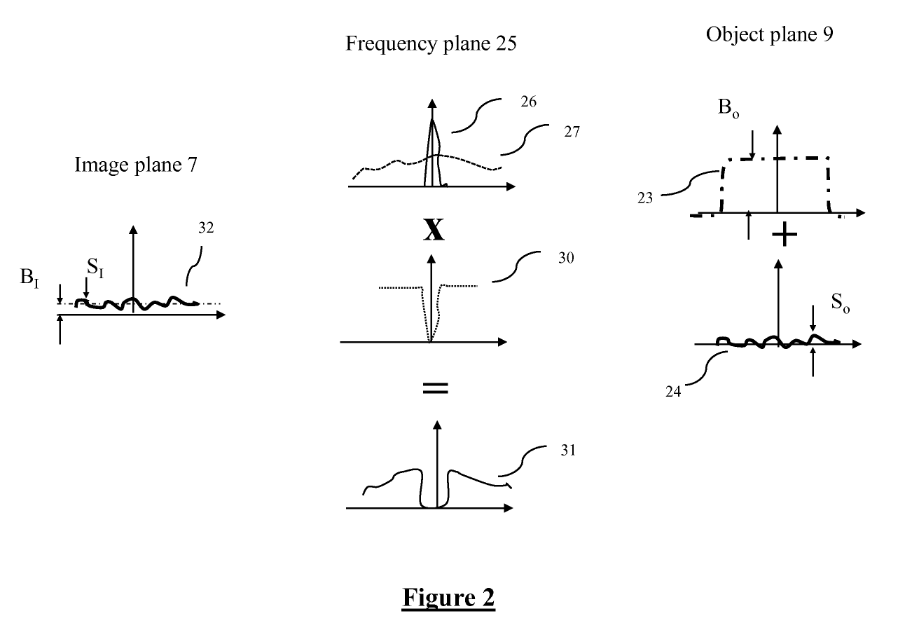

The first embodiment 100 of the aforementioned first class of optical imaging methods and devices is described with reference to the illustrations of FIGS. 1a, 1b and 2. The optical imaging device of FIG. 1a is shown to be comprising of a single wavelength coherent source 1, such as a laser diode, a beam splitter 2, an objective lens 3, a spatial filter 4 and an imaging lens 5. The optical imaging device 100 provides a means for forming a high contrast image 6, located in the front focal plane 7 of the imaging lens 5, of the object 8 located in the front focal plane 9 of the objective lens 3. The coherent source 1, located in the back focal plane 10 of the objective lens 3 produces a diverging wave field 11, whose direction changes by means of the beam splitter 2. The objective lens 3, located in the plane 12 produces a collimated wavefield 13, which illuminates the object 8, located in the front focal plane 9 of the objective lens 3. As can be seen in the close-up view of FIG. 1b, here either the amplitude features 14 etched on a highly reflective surface 15, or cellular structures 16 within a tissue sample 17, or fluorescent molecules 18 attached to a glass surface 19, or the like is considered to define object features.

Referring to FIGS. 1a and 2, typically, two wavefields emanate from the object 8 in response to the collimated illumination 13: a background optical wavefield 20, which is essentially a plane wave, and a diverging wave field 21 from any spatial feature 22 of the object 8. Typically, the wavefield, in a coherent system, is characterized by a complex amplitude expressed in a plane transverse to the direction of propagation. The intensity 23, which is proportional to the square of the complex amplitude, of the background wavefield 20 is much stronger than the intensity 24 of the object features. When this type of object or the like is captured using a two-dimensional photo-detector of a conventional imaging system, the image contrast S_{I}/B_{I}, will be smaller than the object contrast Sₒ/Bₒ, which is very low producing an image of poor quality. S_{I} and B_{I} represent the average intensity of the image features and of the background, respectively, in the image plane 7. For conventional imaging systems, S_{I} is much smaller than B_{I}.

The complex amplitude in the back focal plane 25, referred to as the spatial frequency plane, of the objective lens 3, such as a converging lens, is proportional to the Fourier transform of the complex amplitude in the front focal plane 9. The complex amplitude in the spatial frequency plane 25 is a superposition of the Fourier transforms of the object 24 and background 23 complex amplitudes in the object plane 9 (FIG. 2). The uniform bright object background transforms into a narrow distribution 26 at the origin of the spatial frequency plane 25 (FIG. 2), while the object wavefield 24 transforms to a wider distribution 27 in the frequency plane 25 (FIG. 2). A spatial filter 4, FIG. 1b, with an opaque region 28 and a transparent region 29, placed at the spatial frequency plane 25 (see the close-up view in FIG. 1b), with transmittance 30 (FIG. 2) selectively removes the low frequency components of the composite complex amplitude in the spatial frequency plane. The complex amplitude 31 (FIG. 2), immediately behind the spatial frequency filter 4, corresponds to the frequency components representing the object features 14 or 16 or 18 or the like (see the close up view in FIG. 1b). The complex amplitude 32 (FIG. 2) in the front focal plane 7 of the imaging lens 5 located at plane 33 is a high contrast image of the object 24. A photo-detector 34 can then record the resulting high contrast image, that is, S_{I} is larger than the background B_{I}

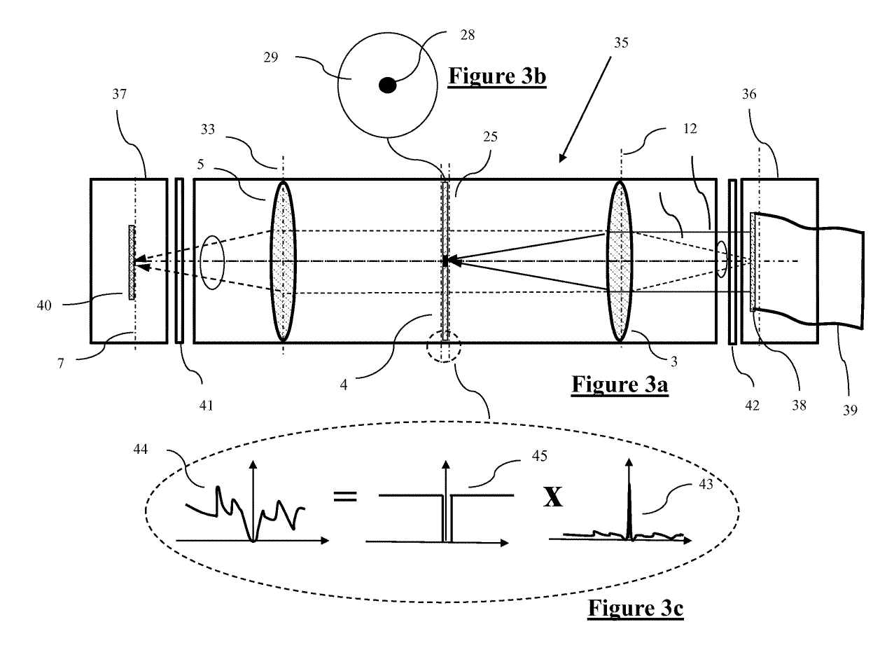

FIG. 3a illustrates the functional block diagram of the second embodiment of the coherent image contrast enhancer device 35, as mounted on a proximal end of a rigid endoscope. The embodiment 35 belongs to the aforementioned first class of optical imaging methods and devices. The design and operation of the coherent image contrast enhancer device 35 is herein described as applied to a typical endoscope used, for example, in laparoscopy surgery.

In the absence of the coherent image contrast device 35, the proximal end 36 of the rigid endoscope, which for the case of laparoscopy surgery is inserted into a human cavity for the purpose of visualization as an aid to surgery, is mated directly to an image recording device 37, such as a video camera. A second rigid endoscope, not shown here, typically provides illumination of the object. Such systems provide for in vivo imaging, for example, in laparoscopy surgery. The rigid endoscope transports the distal image to the proximal end 38 by means of relay lenses or a coherent fiber bundle 39 or the like. The image on the distal end is recorded by means of two dimensional photo-detectors 40, CCD (charge coupled device), CMOS (complementary metal oxide semiconductor), EM-CCD (electron multiplying CCD) CCD or the like in the image recording device 37. The subsequent image is transferred to a monitor for display.

As was previously described, minimal improvements in the image contrast is possible through the use of post-detection digital signal processing due to the nature of the aforementioned emanating two wavefields. In this embodiment, the contrast enhancer device section 35 is used to achieve an order of magnitude increase in the endoscope imaging contrast.

The contrast enhancer device section 35 can be inserted between the photo-detector 37 and the proximal end 36 of the endoscope and held in position by means of mounting rings 41 and 42. As was described for the embodiment 100 of FIG. 1a and using the same numerals for identifying the same components in the contrast enhancer device section 35 of FIG. 3a, the objective lens 3 and the imaging lens 5, together with the spatial filter 4, located in the focal plane 25 form a high contrast image onto the surface of the photo-detector array 40 (34 in FIG. 1a).

The spatial filter 4, FIG. 3b, fabricated with an absorbing opaque spot 28 (which can be fabricated as a diverting reflective surface) blocks the background energy from the spatial frequency distribution 43, while transmitting the object energy 44 without attenuation (see the close up view in FIG. 3c), through the region 29. The transmittance function 45 of a typical spatial filter 4 transmits the object signal only. The imaging lens 5 forms a high contrast image of the object signal. It should be noted that for the purpose of illustration an amplitude only spatial filter has been described here. However, in general, the spatial filter 4 can be complex, permitting modification of the phase (wavefront) of the wavefield, in addition to its amplitude. Phase filtering allows for correcting wavefront aberrations.

Although a rigid endoscope is shown, the contrast enhancer device section 35 can also be used with a flexible endoscope having an articulated insertion section and having an illumination means, such as a light guide bundle or one or more LED's for illumination. The contrast enhancer device section 35 can also be configured for use inside the casing of a capsule endoscope device.

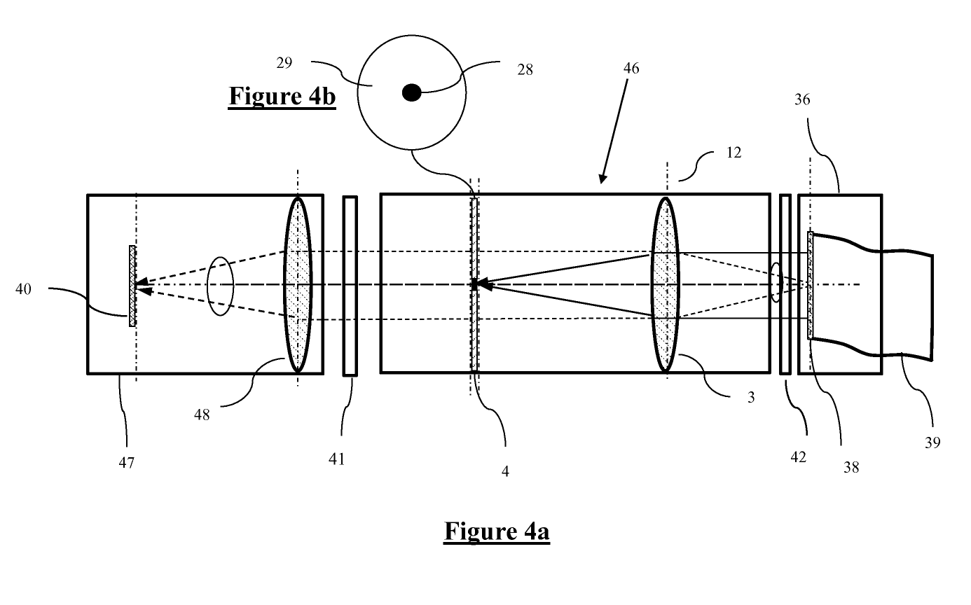

FIG. 4a illustrates the functional block diagram of the third embodiment of the coherent image contrast enhancer device 46 designed for use with a camera system 47, with an integral imaging lens 48 (lens 5 in FIGS. 1a and 3a). The image contrast enhancer device embodiment 46 is designed with the objective lens 3 and the spatial filter 4, connects the coherent image contrast enhancer 46 between the proximal end 38 of the endoscope and the camera photo-detectors or the like image recording member 40, with coupling rings 41 and 42.

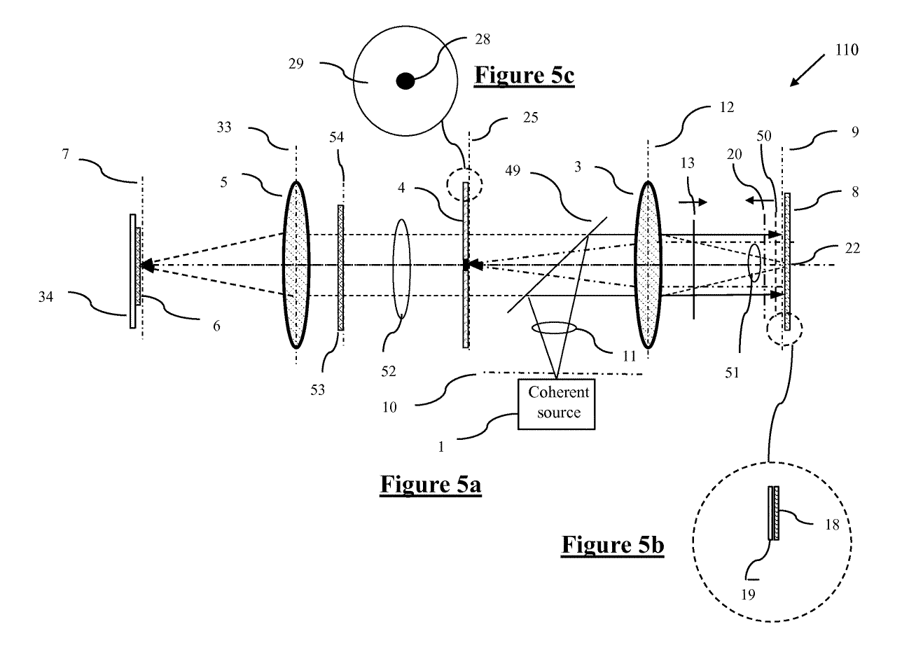

FIG. 5a illustrates the functional block diagram of the coherent image contrast enhancer device of a fourth embodiment 110. This device provides coherent image contrast enhancement at wavelength λ_{EM} which is different from the object illumination wavelength λ_{EX}. This includes forming an image of the fluorescent features of the object. In particular, image enhancement is possible through the use of selective fluorescent tagging of cellular structures or organisms. In these situations, the illumination wavelength also referred to as excitation is shorter than the fluorescent emission from the sample under study. The excitation and emission wavelength are separated through the use of wavelength selective optical components, for example, dichroic mirrors and optical filters. Fluorescent detection provides the lowest detection limits of all analytical instruments. However, further improvements are still possible if the sample autofluorescence, which appears as a bright background, can be further rejected. In other cases, such as microarray readers used for gene expression studies, falls into a class of objects where the fluorescent targets 18 are attached to the surface of a glass slide 19, FIG. 5b, which adds to the fluorescent background as a significant amount of excitation energy bleeds through the optical filters. This fourth embodiment 110 decreases the detection limit through improvement of the image contrast through the use of the disclosed image contrast enhancement device and method described for the embodiment of FIG. 1a.

In the embodiment 110 of FIG. 5a, the coherent source 1, located in the back focal plane 9 of the objective lens 3 produces a diverging wave field 11 at the excitation wavelength λ_{EX}, which can reflect at the dichroic mirror 49. The objective lens 3, located in the plane 12 produces a collimated wavefield 13, which illuminates the composite object 8, located in the front focal plane 9 of the objective lens 3. The object, fluorescently tagged molecules 18, attached to either or both surfaces of a glass slide 19, or the like emit radiation at a wavelength λ_{EM}. Typically, three wavefields emanate from the composite object 8, in response to the collimated illumination 13: a background optical wavefield 20, which is essentially a plane wave, at the excitation wavelength; a background optical wavefield 50, which is essentially a plane wave at the emission wavelength, and a diverging wavefield 51 from the fluorescent molecules 18. The dichroic mirror 49 blocks the background wavefield at the excitation wavelength and transmits the optical signals above the emission wavelength. This transmitted signal 52 is a superposition of the autofluorescence as well as the fluorescent signal from the target molecules. The spatial filter 4, FIG. 5c, removes the autofluorescence signal as well as any small amount of the excitation energy that bleeds through the dichroic mirror. Further suppression of the excitation energy is possible by adding notch filter 53 at any convenient plane 54 between planes 25 and 33. The complex amplitude 31 (FIG. 2) in the front focal plane of the imaging lens 5 located at plane 7 is a high contrast image of the object 24 (FIG. 2). A photo-detector 34 records the high contrast image. The photo-detector 34 can be a point detector such an avalanche photodiode or a photomultiplier or the like.

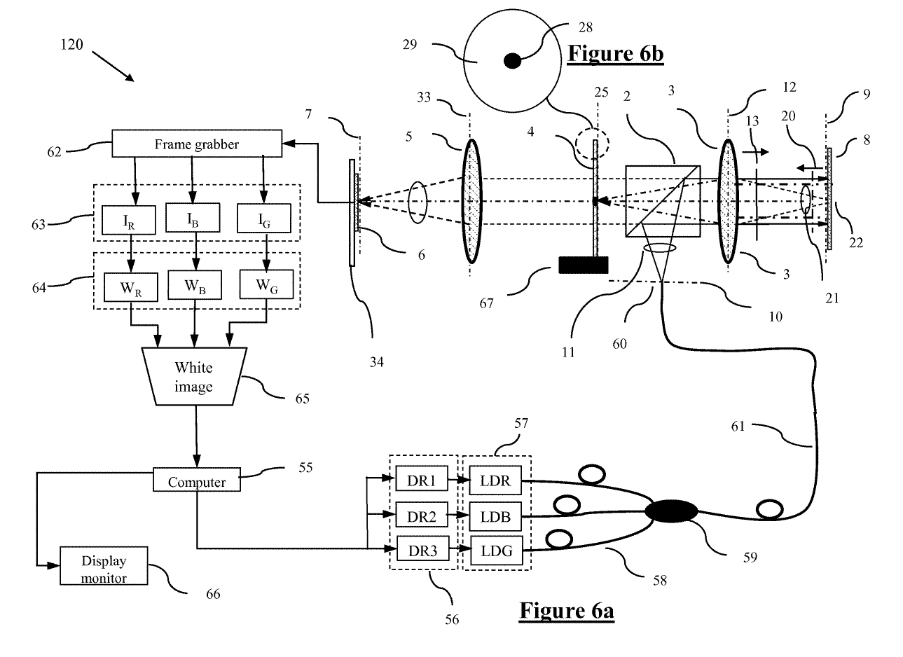

In the above embodiments, the imaging systems use a single wavelength source for obtaining a high contrast image of an object with a bright background. In some applications, however, it may be desirable to have more than a single wavelength source to achieve improvement on the imaging contrast by, for example, introducing excitation of various contrasting agents or by introducing certain range of colors or achieve a high contrast white light image. FIG. 6a illustrates the functional diagram of one embodiment 120 of the aforementioned second class of high contrast imaging systems with multi-wavelength coherent light sources for object illumination for the purpose of providing high contrast imaging in certain spectral range or even in full color.

As can be seen in the functional diagram of FIG. 6a of the embodiment 120 of the imaging system device with multi-wavelength coherent light sources for object illumination, the system consists of a computer 55 or similar electronic processor that synchronizes illumination and recording of the corresponding high contrast image of the object 8. Two or more laser diode drivers 56 drive coherent wavelength sources 57. The coherent sources 57, typically laser diodes, can be pigtailed to single-mode fibers 58, which terminate into an N×1 multiplexer 59. The two (N=2) or more coherent wavelength sources 57 may be of any desired colors. When it is desired to form an equivalent white light image, three coherent sources, blue, red and green are sufficient.

The distal end 60 of the output single-mode fiber 61, is positioned in the back focal plane 10 of the objective lens 3. The diverging wavefield 11 from the single-mode fiber illuminates the object 8 with a plane wavefield 13. A beam splitter 2, an objective lens 3, a spatial filter 4 and an imaging lens 5, provides a means for forming a high contrast image 6, located in the front focal plane 7 of the imaging lens 5, of the object 8 located in the front focal plane 9 of the objective lens 3 as was previously described for the embodiments of FIG. 1a.

The wavelength selectable coherent light source at the distal end 60 of the output single-mode fiber 61 which is located in the back focal plane 10 of the objective lens 3 produces a diverging wave field 11, whose direction changes by means of the beam splitter 2. The objective lens 3, located in the plane 12 produces a collimated wavefield 13, which illuminates the object 8, located in the front focal plane 9 of the objective lens 3. Now referring to FIG. 2, the amplitude features 14 etched on a highly reflective surface 15 is intended to define the object, or cellular structures 16 within a tissue sample 17 or fluorescent molecules 18 attached to a glass surface 19 or the like define object features. As was previously described for the embodiment 100 of FIG. 1a, typically, two wavefields emanate from the object 8, in response to the collimated illumination 13, a background optical wavefield 20, which is essentially a plane wave, and a diverging wave field 21 from any spatial feature 22 of the object 8. Typically, the wavefield, in a coherent system, is characterized by a complex amplitude expressed in a plane transverse to the direction of propagation. As was previously described, the intensity 23 (FIG. 2), which is proportional to the square of the complex amplitude, of the background wavefield 20 is much stronger than the intensity 24 of the object features (FIG. 2). When this type of object or the like is captured using a two-dimensional photo-detector of a conventional imaging system, the image contrast S_{I}/B_{I}, will be smaller than the object contrast Sₒ/Bₒ, which is very low producing an image of poor quality. S_{I} and B_{I} represent the average intensity of the image features and of the background, respectively, in the image plane 7. For conventional imaging systems, S_{I} is much smaller than B_{I}

The complex amplitude in the back focal plane 25, referred to as the spatial frequency plane of the objective lens 3, such as a converging lens, is proportional to the Fourier transform of the complex amplitude in the front focal plane 9. The complex amplitude in the spatial frequency plane 25 is a superposition of the Fourier transforms of the object 24 and background 23 complex amplitudes, (see FIG. 2), in the object plane 9. The uniform bright object background transforms into a narrow distribution 26 (FIG. 2) at the origin of the spatial frequency plane 25, while the object wavefield 24 (FIG. 2) transforms to a wider distribution 27 in frequency plane. A spatial filter 4, FIG. 6b, with an opaque region 28 and a transparent region 29, placed at the spatial frequency plane 25, FIG. 6a, with transmittance 30, FIG. 2, selectively removes the low frequency components of the composite complex amplitude in the spatial frequency plane. The complex amplitude 31 (FIG. 2) immediately behind the spatial frequency filter 4, corresponds to the frequency components representing the object features 14 or 16 or 18 (FIG. 1a) or the like.

The complex amplitude 32 (FIG. 2) in the front focal plane of the imaging lens 5 located at plane 7 (FIG. 2) is a high contrast image of the object 24 (FIG. 2). With reference to FIGS. 2 and 6a, a photo-detector 34, typically a CCD, records the high contrast image 6 for a given source wavelength. A frame grabber 62 captures the image and saves it to a storage device. By this means, three images 63, for each of the coherent source wavelengths, are sequentially captured and saved. Weighted averaging 64 of the saved images leads to an equivalent white light image 65. A remote monitor 66 displays the in vivo white light image. The weights 65 are determined by imaging a white object, or other preferred reference color.

In the above embodiments, the opaque element (28 in FIGS. 1a, 3a-6a) is used to block the illumination arriving at the element surface area. Typically, the blocking by means of using wavelength specific materials is preferred as the unwanted energy is not reflected back into the transmission path. However, absorption of energy will result in localized temperature increases, which can be mitigated by using thermally conductive transparent coatings 28 in FIG. 2. In the specific casing when the thermal loading cannot be mitigated by these means, the blocking functionality may be achieved by means of a reflective region 29 of FIG. 1a, which is oriented to send the reflected light out of the transmitting path to suitable light trapping geometries. It should be noted that these methods for rejecting the unwanted light apply to all the above embodiments.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A device comprising:
a light source for outputting illumination light to an object to be imaged;
an image sensor for an image of the object as illuminated by the light source;
a first objective lens for focusing the illumination light on the object; and
a spatial filter positioned in an optical path at a spatial frequency plane of the first objective lens, the spatial filter having an opaque central region and a transparent region outside of the central region, the opaque central region being such that it improves contrast of the image on the image sensor.

2. The device of claim 1, further comprising a second objective lens for focusing the image on a surface of the image sensor.

3. The device of claim 1, wherein the opaque region removes low frequency components of a composite complex amplitude in the spatial frequency plane.

4. The device of claim 1, wherein the central portion includes a surface that absorbs the illumination light from the light source.

5. The device of claim 1, wherein the central portion includes a surface that reflects the illumination light from the light source.

6. The device of claim 1, wherein the light source is a coherent light source.

7. An endoscope having the device of claim 1.

8. A microscope having the device of claim 1.

9. A device for use with a light source for outputting illumination light to an object to be imaged and an image sensor for an image of the object as illuminated by the light source, the device comprising:
a first objective lens for focusing the illumination light on the object; and
a spatial filter positioned in an optical path at a spatial frequency plane of the first objective lens, the spatial filter having an opaque central region and a transparent region outside of the central region, the opaque central region being such that it improves contrast of the image on the image sensor.

10. The device of claim 9, further comprising a second objective lens for focusing the image on a surface of the image sensor.

11. The device of claim 9, wherein the opaque region removes low frequency components of a composite complex amplitude in the spatial frequency plane.

12. The device of claim 9, wherein the central portion includes a surface that absorbs the illumination light from the light source.

13. The device of claim 9, wherein the central portion includes a surface that reflects the illumination light from the light source.

14. The device of claim 9, wherein the light source is a coherent light source.

15. The device of claim 9, further comprising one or more connectors for attaching the device to an endoscope.

16. The device of claim 9, further comprising one or more connectors for attaching the device to a microscope.

17. A method of improving contrast in an image captured by an imaging sensor, the method comprising:
placing an objective lens in an optical path of illumination light on the object; and
filtering out a central portion of the illumination light returning from the object at a spatial frequency plane of the objective lens to improves the contrast of the image on the imaging sensor.

18. The method of claim 17, where the filtering comprises absorbing the central portion of the illumination light returning from the object.

19. The method of claim 17, where the filtering comprises reflecting the central portion of the illumination light returning from the object.
